(19) United States
(12) Patent Application Publication
(10) Pub. No.: US 2025/0371100 A1
(43) Pub. Date: Dec. 4, 2025

(54) EFFICIENT SAMPLING FOR THEOREM PROVING

(71) Applicant: International Business Machines Corporation, Armonk, NY (US)

(72) Inventors: Akihiro Kishimoto, Setagaya (JP); Achille Belly Fokoue-Nkoutche, White Plains, NY (US); Ibrahim Abdelaziz, Tarrytown, NY (US); Radu Marinescu, Dublin (IE); Ndivhuwo Makondo, Pretoria (ZA); Vernon Ralph Austel, Cortlandt Manor, NY (US); Guilherme Augusto Ferreira Lima, Rio de Janeiro (BR); Maxwell Crouse, Chicago, IL (US); Shajith Ikbal Mohamed, Chennai (IN)

(21) Appl. No.: 18/731,487

(22) Filed: Jun. 3, 2024

(51) Int. Cl. G06F 17/11

(52) U.S. Cl. CPC G06F 17/11

(57) ABSTRACT

Examples described herein provide a computer-implemented method that includes setting a sampling step size and a constant value as parameters to solve a theorem proving problem. The method further includes performing a first sampling step starting with an initial state of the theorem proving problem and limited by the sampling step size. The method further includes determining whether the theorem proving problem is solved. The method further includes, responsive to determining that the theorem proving problem is not solved, increasing the sampling step size based on the constant value to define an increased sampling step size. The method further includes performing a second sampling step limited by the increased sampling step size.

### BACKGROUND

The present disclosure relates to computing systems, and more specifically, to efficient sampling for theorem proving.

In mathematics, when given a conjecture (e.g., a logical clause having an unknown truth value) and a set of axioms (e.g., one or more logical clauses that are known, deemed, or defined to be true), it can be desired to create a proof for the conjecture (e.g., to apply a sequence of sound inferencing rules to the set of axioms so as to prove or disprove the conjecture). Historically, proofs have been manually written by mathematicians. Recently, however, much research has been poured into the field of automated theorem proving.

Automated theorem proving can be considered as a technical field that focuses on enabling computers to perform specialized electronic computations to electronically generate proofs without human intervention. A computer that has been constructed or programmed according to the field of automated theorem proving can be referred to as an automated theorem prover (ATP). At its core, automated theorem proving can be considered as a complex search problem, where construction of a proof is treated as an electronic search through available inferencing rules until a satisfactory conclusion is reached.

### SUMMARY

In one embodiment, a method is provided. The method includes setting a sampling step size and a constant value as parameters to solve a theorem proving problem. The method further includes performing a first sampling step starting with an initial state of the theorem proving problem and limited by the sampling step size. The method further includes determining whether the theorem proving problem is solved. The method further includes, responsive to determining that the theorem proving problem is not solved, increasing the sampling step size based on the constant value to define an increased sampling step size. The method further includes performing a second sampling step limited by the increased sampling step size.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a computing environment, according to an embodiment;

FIG. 2 illustrates a block diagram of components of a machine learning training and inference system, according to an embodiment;

FIG. 3 illustrates a flow diagram of a method for performing efficient sampling for theorem proving, according to an embodiment;

FIG. 4 illustrates a flow diagram of a method for training a machine learning model to solve theorem proving problems, according to an embodiment; and

FIG. 5 depicts a table that compares the results of one or more embodiments described herein to a Monte Carlo-based sampling approach for a random model and a well-trained model, according to an embodiment.

The detailed description explains embodiments of the disclosure, together with advantages and features, by way of example with reference to the drawings.

### DETAILED DESCRIPTION

Automated theorem proving has applications to various technologies, such as code generation, hardware verification, and/or the like. In some cases, theorem proving problems can be solved in a few steps. However, in other cases, a solution to a theorem proving problem may have hundreds or even thousands of steps. That is, in automated theorem proving, the lengths of action sequences (e.g., solutions) can significantly vary depending on the problem, and the length of a solution is unknown before the solution is identified.

One technique to perform theorem proving is to use a Monte Carlo-based sampling approach. Because the length of a solution is unknown before the solution is identified, the Monte Carlo-based sampling approach does not bound a sampling step size. When attempting to solve one problem, only one sampling is performed, which examines a selected sequence as deep as possible within a given time limit. However, performing only one unbounded sample has certain drawbacks, including returning a longer action sequence as the solution when a shorter action sequence may be possible and failing to identify a solution in an incorrect action is selected.

Reinforcement learning has been applied in other domains to introduce a constant limit to the sampling size, including AlphaGo/AlphaZero for the game of Go. Such approaches have heretofore been unsuitable for theorem proving. Unlike theorem proving, using reinforcement learning to introduce a constant limit to the sampling size assumes that most of the samplings can obtain meaningful outcomes (e.g., win/loss and a score of the game) within the constant time. This is not the case in theorem proving where nearly all outcomes are incorrect solutions and only a limited number of true solutions (if any) exist. Moreover, in theorem proving, due to a very large variance to the solution length, setting a large sampling step size limit suffers from the same drawbacks described regarding the Monte Carlo-based sampling approach. Setting a small sampling step size leads to not being able to solve problems that have longer action sequences as solutions.

Other areas of research have also been considered for solving theorem proving problems. However, these approaches also have undesirable drawbacks. For example, iterative deepening undesirably increases the search space by a branching factor when the depth is incremented by one, causing a large and undesirable increase in computational complexity. As another example, random restarting deals only with solutions having a length known before hand, which is not the case in solving theorem proving problems.

One or more embodiments described herein address these and other shortcomings by providing efficient sampling for theorem proving. According to one or more embodiments, a theorem proving problem is received and solved by initializing a sampling step size limit, performing a sampling within the sampling step size limit, determining whether the sampling solves the theorem proving problem, and increasing the sampling step size limit when the theorem proving problem is not solved. When the theorem proving problem is solved, an action sequence is returned as the solution to the theorem proving problem.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

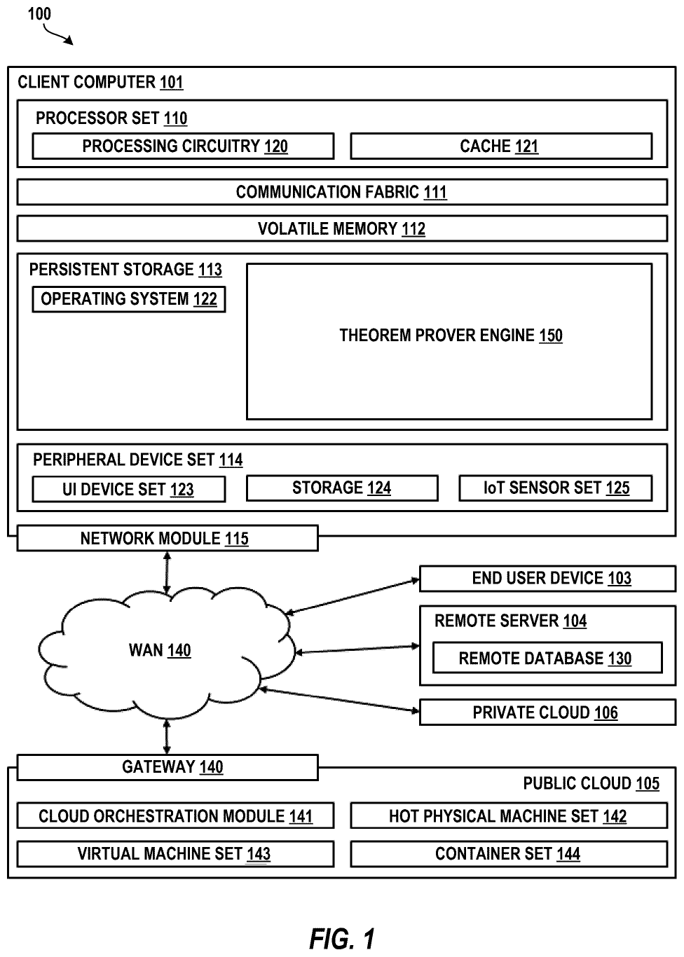

FIG. 1 illustrates a computing environment 100, according to an embodiment. Computing environment 100 contains an example of an environment for the execution of at least some of the computer code involved in performing the inventive methods, such as a theorem prover engine 150, which may be used to perform automated theorem proving. In addition to theorem prover engine 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and theorem prover engine 150, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in theorem prover engine 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in theorem prover engine 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments described herein can utilize machine learning techniques to perform tasks, such as automated theorem proving. More specifically, one or more embodiments described herein can incorporate and utilize rule-based decision making and artificial intelligence (AI) reasoning to accomplish the various operations described herein, namely automated theorem proving. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” and/or “trained machine learning model”) can be used for automated theorem proving, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of automated theorem proving as described herein.

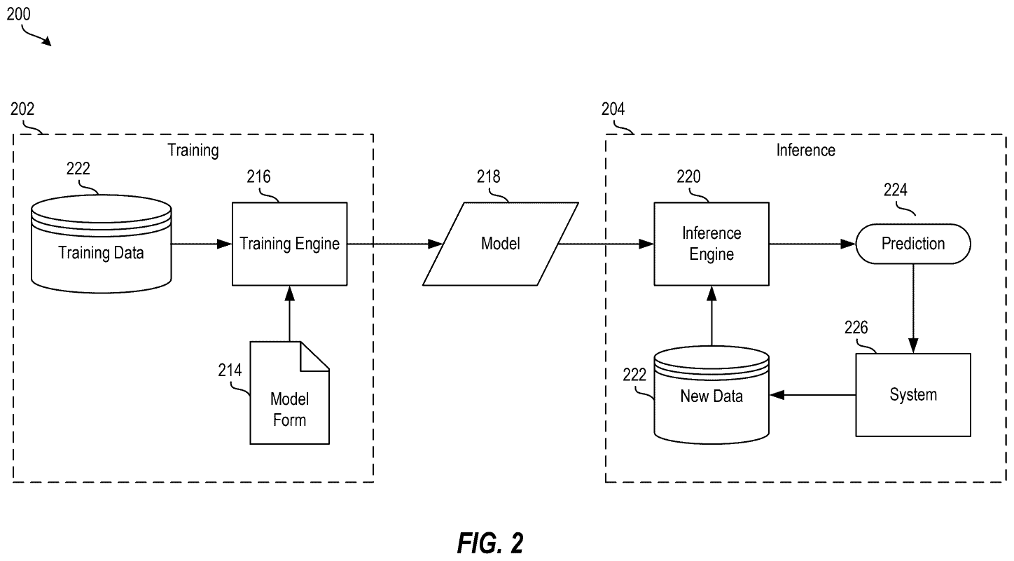

Systems for training and using a machine learning model are now described in more detail with reference to FIG. 2. Particularly, FIG. 2 depicts a block diagram of components of a machine learning training and inference system 200 according to one or more embodiments described herein. The machine learning training and inference system 200 performs training 202 and inference 204. During training 202, a training engine 216 trains a model (e.g., the trained model 218) to perform a task, such as to solve a theorem proving problem. Inference 204 is the process of implementing the trained model 218 to perform the task, such as to solve a theorem proving problem, in the context of a larger system (e.g., a system 226). All or a portion of the machine learning training and inference system 200 shown in FIG. 2 can be implemented, for example by all or a subset of the theorem prover engine 150 of FIG. 1.

The training 202 begins with training data 212, which may be structured or unstructured data. According to one or more embodiments described herein, the training data 212 includes an action sequence for a theorem proving problem. As used herein, the phrase “action sequence” refers to a series of steps to solve the theorem proving problem. According to one or more embodiments, the training data 212 includes a theorem proving problem (p), parameters (e.g., a sampling step size and a constant value) to solve the theorem proving problem (p), and a solution of the theorem proving problem (p) (e.g., an action sequence). The training engine 216 receives the training data 212 and a model form 214. According to one or more embodiments described herein, the model form 214 represents a base model that is untrained. The model form 214 can have preset weights and biases, which can be adjusted during training. It should be appreciated that the model form 214 can be selected from many different model forms depending on the task to be performed. For example, where the training 202 is to train a model to perform automated theorem proving, the model form 214 may be a model form of a deep Q-learning model, although other types of model forms and/or algorithms can be implemented.

According to one or more embodiments described herein, the model form 214 represents an algorithm that can be trained to perform a particular task. In some embodiments, the model form 214 is an algorithm that can include, for example, supervised learning algorithms, unsupervised learning algorithm, artificial neural network algorithms, association rule learning algorithms, hierarchical clustering algorithms, cluster analysis algorithms, outlier detection algorithms, semi-supervised learning algorithms, reinforcement learning algorithms and/or deep learning algorithms. Examples of supervised learning algorithms can include, for example, AODE; Artificial neural network, such as Backpropagation, Autoencoders, Hopfield networks, Boltzmann machines, Restricted Boltzmann Machines, and/or Spiking neural networks; Bayesian statistics, such as Bayesian network and/or Bayesian knowledge base; Case-based reasoning; Gaussian process regression; Gene expression programming; Group method of data handling (GMDH); Inductive logic programming; Instance-based learning; Lazy learning; Learning Automata; Learning Vector Quantization; Logistic Model Tree; Minimum message length (decision trees, decision graphs, etc.), such as Nearest Neighbor algorithms and/or Analogical modeling; Probably approximately correct learning (PAC) learning; Ripple down rules, a knowledge acquisition methodology; Symbolic machine learning algorithms; Support vector machines; Random Forests; Ensembles of classifiers, such as Bootstrap aggregating (bagging) and/or Boosting (meta-algorithm); Ordinal classification; Information fuzzy networks (IFN); Conditional Random Field; ANOVA; Linear classifiers, such as Fisher's linear discriminant, Linear regression, Logistic regression, Multinomial logistic regression, Naive Bayes classifier, Perceptron, and/or Support vector machines; Quadratic classifiers; k-nearest neighbor; Boosting; Decision trees, such as C4.5, Random forests, ID3, CART, SLIQ, and/or SPRINT; Bayesian networks, such as Naive Bayes; and/or Hidden Markov models. Examples of unsupervised learning algorithms can include Expectation-maximization algorithm; Vector Quantization; Generative topographic map; and/or Information bottleneck method. Examples of artificial neural network can include Self-organizing maps. Examples of association rule learning algorithms can include Apriori algorithm; Eclat algorithm; and/or FP-growth algorithm. Examples of hierarchical clustering can include Single-linkage clustering and/or Conceptual clustering. Examples of cluster analysis can include K-means algorithm; Fuzzy clustering; DBSCAN; and/or OPTICS algorithm. Examples of outlier detection can include Local Outlier Factors. Examples of semi-supervised learning algorithms can include Generative models; Low-density separation; Graph-based methods; and/or Co-training. Examples of reinforcement learning algorithms can include Temporal difference learning; Q-learning; Learning Automata; and/or SARSA. Examples of deep learning algorithms can include Deep belief networks; Deep Boltzmann machines; Deep Convolutional neural networks; Deep Recurrent neural networks; and/or Hierarchical temporal memory.

According to one or more embodiments described herein, the model form 214 is a foundational model that is trained on a wide variety of generalized, unlabeled training data to perform one or more different general tasks, such as generating content (text, images, etc.), performing natural language processing, and/or the like including combinations and/or multiples thereof. In the case of the model form 214 being a foundational model, the training 202 can include tuning the foundational model (e.g., the model form 214) using the training data 212. Tuning the foundational model provides the benefits of the broad capabilities of the foundational model while enabling the foundational model to be customized using training data (e.g., the training data 212) related to a particular task or environment to which the foundational modal is then applied. In this way, the training 202 need not train a new model from scratch, which is time-consuming and resource intensive.

The training 202 can be supervised learning, semi-supervised learning, unsupervised learning, reinforcement learning, and/or the like, including combinations and/or multiples thereof. For example, supervised learning can be used to train a machine learning model to perform automated theorem proving. To do this, the training data 212 includes theorem proving problems and associated solutions (e.g., action sequences), which serves as a ground truth. In this example, the training engine 216 takes as input a theorem proving problem from the training data 212, makes a prediction for solving the theorem proving problem, and compares the prediction to the known action sequence (e.g., ground truth). The training engine 216 then adjusts weights and/or biases of the model based on results of the comparison, such as by using backpropagation. The training 202 may be performed multiple times (referred to as “epochs”) until a suitable model is trained (e.g., the trained model 218).

Once trained, the trained model 218 can be used to perform inference 204 to perform a task, such as to perform automated theorem proving. The inference engine 220 applies the trained model 218 to new data 222 (e.g., real-world, non-training data). For example, if the trained model 218 is trained to solve theorem proving problems, the new data 222 can be theorem proving problem that was not part of the training data 212. In this way, the new data 222 represents data to which the trained model 218 has not been exposed. The inference engine 220 makes a prediction 224 (e.g., a theorem proving problem of the new data 222) and passes the prediction 224 (e.g., an action sequence representing a solution to the problem) to the system 226 (e.g., the computer 101 of FIG. 1). The system 226 can, based on the prediction 224, taken an action, perform an operation, perform an analysis, and/or the like, including combinations and/or multiples thereof. In some embodiments, the system 226 can add to and/or modify the new data 222 based on the prediction 224.

In accordance with one or more embodiments, the predictions 224 generated by the inference engine 220 are periodically monitored and verified to ensure that the inference engine 220 is operating as expected. Based on the verification, additional training 202 may occur using the trained model 218 as the starting point. The additional training 202 may include all or a subset of the original training data 212 and/or new training data 212. In accordance with one or more embodiments, the training 202 includes updating the trained model 218 to account for changes in expected input data.

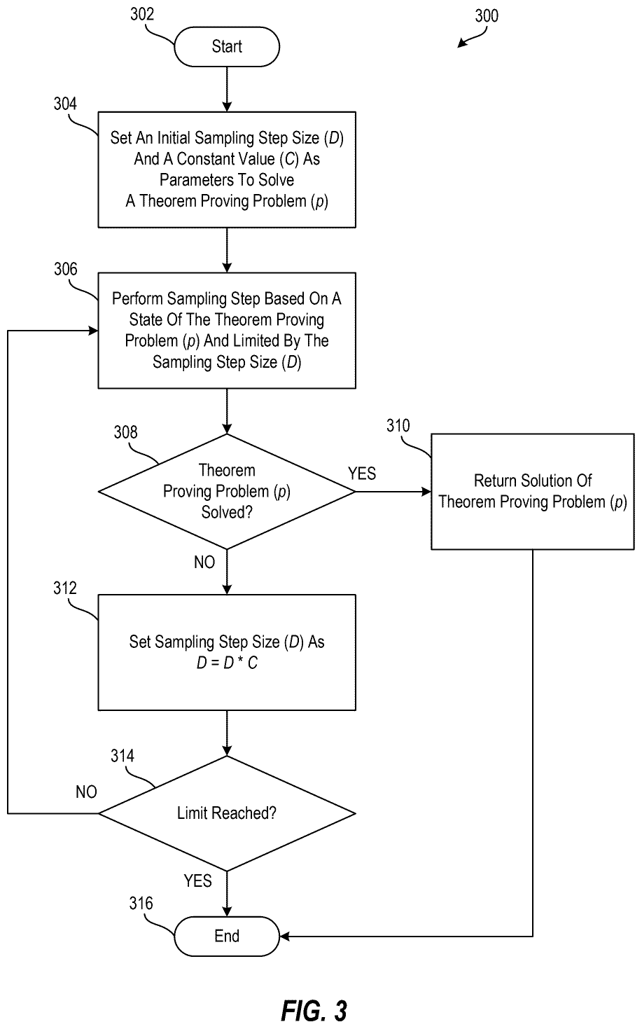

Turning now to FIG. 3, a flow diagram of a method 300 for performing efficient sampling for theorem proving is provided, according to an embodiment. The method 300 can be performed by any suitable computing system, device, or environment, such as those described herein (e.g., the computing environment 100 and/or the computer 101 of FIG. 1). According to one or more embodiments, the method 300 is performed, in whole or in part, using the theorem prover engine 150 of FIG. 1.

The method 300 begins at block 302. At block 304, parameters for solving a theorem proving problem (p) are set. For example, the parameters include an initial sampling step size (D) (also referred to as “depth”) and a constant value (C).

At block 306, the theorem prover engine 150 performs a sampling step based on a state of the theorem proving problem (p). For example, for a first sampling step, the initial state of the theorem proving problem (p) is used. For subsequent sampling steps (if any), a current state of the theorem proving problem (p) is used. It should be appreciated that each sampling step attempts to solve the theorem proving problem within the depth defined by the sampling step size (D). That is, performing the sampling step is limited by the sampling step size (D). According to one or more embodiments, the theorem prover engine 150 can apply a bias to each action that is applicable to the state, which may be a randomly set bias, for example. The bias intends to give higher probabilities to actions that are more promising to reach a proof of the theorem. That is, a bias is provided to each action so that the Monte Carlo sampling can probabilistically select promising actions more frequently. The bias is applied to a state of the theorem proving problem (p). The state of the theorem proving problem (p) is a set of clauses that have not been satisfied yet. For example, if there are three actions (A, B, and C) applicable to the current state of the theorem proving problem (p), a random sampling assigns a probability of 33.3% to each action. On the other hand, if action A is heuristically known to be much more promising than B and C, a biased sampling can allocate a probability of 80% to A and 10% each to B and C.

At block 308, the theorem prover engine 150 determines whether the theorem proving problem (p) is solved. If so (block 308 “Yes”), the method 300 proceeds to block 310, and the theorem prover engine 150 returns the solution of the theorem proving problem.

If it is determined that the theorem proving problem (p) is not solved (block 308 “No”), the method 300 proceeds to block 312, where the theorem prover engine 150 increases the sampling step size (D) based on the constant value (C) to define an increased sampling step size. For example, the theorem prover engine 150 increases the sampling step size (D) by multiplying the sampling step size (D) by the constant value (C) as follows: D=D*C.

The method 300 then proceeds to block 314, where the theorem prover engine 150 determines whether a solving limit has been reached. Examples of solving limits include, but are not limited to, an allocated time for solving the theorem proving problem (p), a maximum sampling step size for solving the theorem proving problem (p), a maximum number of cycles (e.g., a number of sampling steps) for solving the theorem proving problem (p), and/or the like, including combinations and/or multiples thereof. For example, an allocated time can be set to limit how long the theorem prover engine 150 attempts to solve the theorem proving problem (p), which can improve the efficiency of the theorem prover engine 150 (and thereby the computer 101) by preventing the theorem prover engine 150 from attempting to solve the theorem proving problem (p) indefinitely or until substantially all computing resources of the computing system (e.g., the computer 101) have been consumed. The maximum number of cycles for solving the theorem proving problem (p) and the maximum sampling step size for solving the theorem proving problem (p) also act to limit negative computational impacts to the computing system (e.g., the computer 101). In this way, the functioning of the computing system implementing the theorem prover engine 150 to perform the method 300 is improved.

If it is determined that the allocated time has not expired (block 314 “No”), the method 300 returns to block 306, and the theorem prover engine 150 performs a subsequent sampling step that is limited by the increased sampling step size (e.g., D*C). This process can repeat iteratively until, for example, a solution of the theorem proving problem (p) is identified (blocks 308, 310), until the allocated time as expired (block 314), or until another terminal event occurs.

When it is determined that the allocated time has expired (block 314 “Yes”), or subsequent to a solution of the theorem proving problem being returned (block 310), the method 300 terminates at block 316.

Additional processes also may be included, and it should be understood that the processes depicted in FIG. 3 represent illustrations, and that other processes may be added or existing processes may be removed, modified, or rearranged without departing from the scope of the present disclosure. It should also be understood that the processes depicted in FIG. 3 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

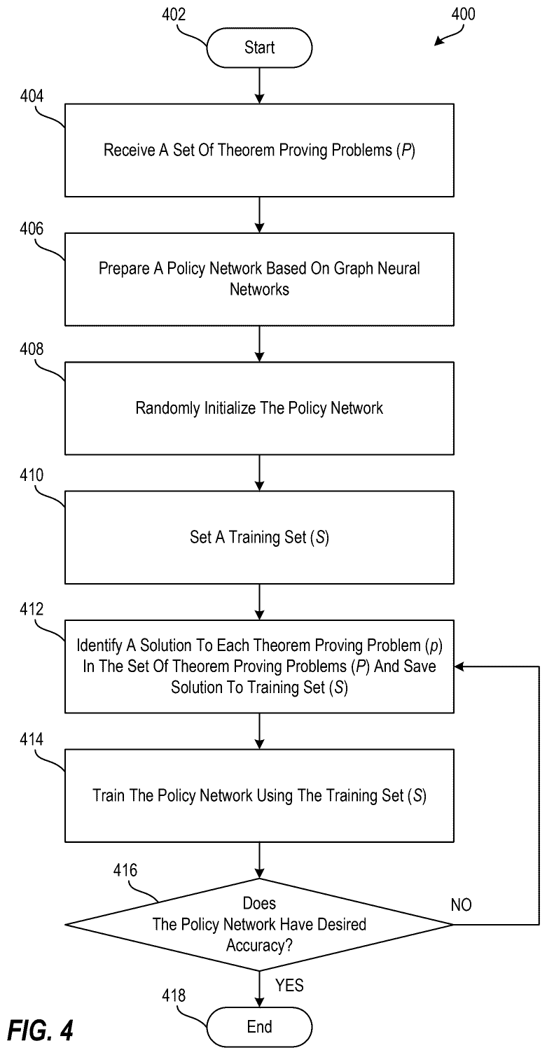

Turning now to FIG. 4, a flow diagram of a method 400 for training a machine learning model to solve theorem proving problems is provided, according to an embodiment. The method 400 can be performed by any suitable computing system, device, or environment, such as those described herein (e.g., the computing environment 100 and/or the computer 101 of FIG. 1). According to one or more embodiments, the method 400 is performed, in whole or in part, using theorem prover engine 150 of FIG. 1.

The method 400 begins at block 402. At block 404, the theorem prover engine 150 receives a set of theorem proving problems (P). At block 406, the theorem prover engine 150 prepares a policy network (NET) based on graph neural networks. An example of such a graph neural network is the name invariant graph representation (NIAGRA) approach, which uses an improved graph neural network for learning name-invariant formula representations tailored to their unique characteristics and an efficient ensemble approach for automated theorem proving. At block 408, the theorem prover engine 150 randomly initializes the policy network (NET). At block 410, the theorem prover engine 150 sets a training set of solutions S={ }. At block 412, the theorem prover engine 150 identifies a solution to each theorem proving problem (p) in the set of theorem proving problems (P). For example, the theorem prover engine 150 uses the method 300 to identify solutions to the theorem proving problem (p) in the set of theorem proving problems (P). The solutions are saved to the training set S. At block 414, the theorem prover engine 150 trains the policy network (NET) using the training set S (e.g., the solutions (e.g., action sequences) to the theorem proving problems (p)). The theorem prover engine 150 may iteratively perform the blocks 412 and 414 until the policy network (NET) has a desired accuracy as determined at block 416. In other words, if it is determined that the policy network (NET) does not have a desired accuracy (block 416 “No”), the method 400 returns to block 412. However, if the policy network (NET) does have a desired accuracy (block 416 “Yes”), the method 400 proceeds to block 418 and terminates, resulting in a trained model for solving theorem proving problems.

Additional processes also may be included, and it should be understood that the processes depicted in FIG. 4 represent illustrations, and that other processes may be added or existing processes may be removed, modified, or rearranged without departing from the scope of the present disclosure. It should also be understood that the processes depicted in FIG. 4 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

It should be appreciated that, iteratively increasing the sampling step size, as described herein, has many advantages. For example, a second sampling that probabilistically selects a different action has a better chance to discover a shorter solution, even if the first sampling takes an action leading to a redundant solution. On the other hand, when an action sequence to a shorter solution is not selected, direct sampling cannot backtrack to the solution. In other words, even if direct sampling finds a solution, that solution is longer. As another example, a second sampling may discover a solution even if the first sampling fails to do so. On the other hand, direct sampling without any sampling step size limit cannot recover from a mistake once an incorrect action is selected.

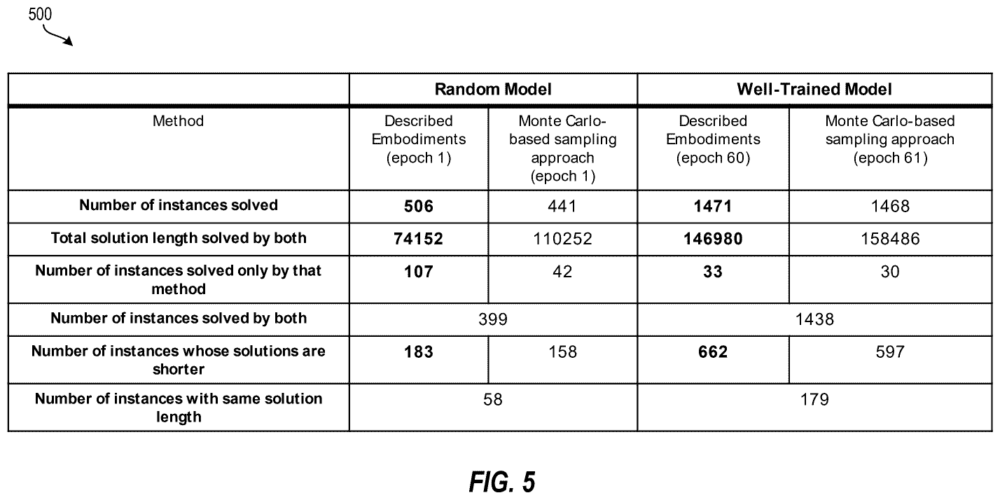

Any extra overhead caused by additional samplings according to one or more embodiments described herein is bounded, which can arbitrary be smaller when certain parameters are selected. Consider the following example. Let the maximum sampling step size MAXD=Dᵢₙᵢₜ×C^{k}. Direct sampling of MAXD requires the time complexity of O(MAXD)=O(ᵢₙᵢₜ×C^{k}). In constrast, one or more embodiments described herein uses the time of Dᵢₙᵢₜ(1+C+C²+ . . . . C^{k}), which results in the time complexity of O(Dᵢₙᵢₜ(C^{k}+1−1)/(C−1) . For large k (e.g., approaching to infinity), the time used by one or more embodiment described herein is C/(C−1) times larger than that of direct sampling. With sufficiently large value for C, the difference in time is insignificant. For example, where C=20, only 5% extra overhead is used as compared to direct sampling. This minor increase in overhead is insignificant when compared to the increased performance, such as that shown in the table 500 of FIG. 5 and described elsewhere herein.

One or more embodiments described herein provide improved computer functionality for solving theorem proving problems and have various applications. For example, one or more embodiments described herein can be used to verify correctness of AI-generated software source code, solving theorem proving problems for large language models (LLMs), and/or the like, including combinations and/or multiples thereof. More particularly, some LLMs suffer from scenarios where an answer that is generated in response to a prompt is correct, but the reasoning behind the answer (e.g., the logical explanation for the answer) is incorrect. Appling automated theorem proving using the one or more embodiments described herein to LLMs can improve the reasoning behind an answer.

According to one or more embodiments, embodiments described herein can be used to provide relatively shorter solutions (e.g., action sequences) to theorem proving problems. By identifying shorter solutions, computer functionality is improved because the computer does not need to use as many computational resources (e.g., processing resources, memory resources, bandwidth resources, data storage resources, and/or the like, including combinations and/or multiples thereof) to identify the shorter solutions as compared with longer solutions. Further, it is easier to interpret a shorter solution than a longer solution.

Improvements over prior approaches, particularly a Monte Carlo-based sampling approach to solving theorem proving problems, can be seen by the table 500 of FIG. 5. Particularly, the table 500 compares the results of one or more embodiments described herein to a Monte Carlo-based sampling approach for a random model and a well-trained model. As can be seen, the one or more embodiments described herein provide better solving abilities as well as about 33% shorter solution lengths (e.g., action sequence lengths) for the random model as compared to the Monte Carlo-based sampling approach. Further, the one or more embodiments described herein provide about 7.3% shorter solution lengths (e.g., action sequence lengths) for the well-trained model as compared to the Monte Carlo-based sampling approach while obtaining better solving results as well.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method comprising:
setting a sampling step size and a constant value as parameters to solve a theorem proving problem;
performing a first sampling step starting with an initial state of the theorem proving problem and limited by the sampling step size;
determining whether the theorem proving problem is solved;
responsive to determining that the theorem proving problem is not solved, increasing the sampling step size based on the constant value to define an increased sampling step size; and
performing a second sampling step limited by the increased sampling step size.

2. The computer-implemented method of claim 1, further comprising, responsive to determining that the theorem proving problem is solved, returning a solution of the theorem proving problem.

3. The computer-implemented method of claim 1, wherein performing the second sampling step is performed until a maximum sampling step size for solving the theorem proving problem (p) is reached.

4. The computer-implemented method of claim 1, wherein performing the second sampling step is performed until an allocated time for solving the theorem proving problem (p) expires.

5. The computer-implemented method of claim 1, wherein performing the second sampling step is performed until a maximum number of cycles for solving the theorem proving problem (p) is reached.

6. The computer-implemented method of claim 1, wherein a bias is applied to a state of the theorem proving problem (p).

7. The computer-implemented method of claim 2, wherein the theorem proving problem (p), the parameters to solve the theorem proving problem (p), and the solution of the theorem proving problem (p) are used to train a machine learning model to solve other theorem proving problems.

8. The computer-implemented method of claim 7, wherein the machine learning model is trained using deep Q-learning.

9. The computer-implemented method of claim 7, wherein the machine learning model is trained using an action sequence.

10. The computer-implemented method of claim 7, further comprising:
calculating, by the machine learning model, a probability of selecting each of a plurality of actions; and
performing, by the machine learning model, a sampling bias based on the probability.

11. A system comprising:
a memory comprising computer readable instructions; and
a processing device for executing the computer readable instructions, the computer readable instructions controlling the processing device to perform operations comprising:
setting a sampling step size and a constant value as parameters to solve a theorem proving problem;
performing a first sampling step starting with an initial state of the theorem proving problem and limited by the sampling step size;
determining whether the theorem proving problem is solved;
responsive to determining that the theorem proving problem is not solved, increasing the sampling step size based on the constant value to define an increased sampling step size; and
performing a second sampling step limited by the increased sampling step size.

12. The system of claim 11, wherein the operations further comprise, responsive to determining that the theorem proving problem is solved, returning a solution of the theorem proving problem.

13. The system of claim 11, wherein performing the second sampling step is performed until a maximum sampling step size for solving the theorem proving problem (p) is reached.

14. The system of claim 11, wherein performing the second sampling step is performed until an allocated time for solving the theorem proving problem (p) expires.

15. The system of claim 11, wherein performing the second sampling step is performed until a maximum number of cycles for solving the theorem proving problem (p) is reached.

16. The system of claim 11, wherein a bias is applied to a state of the theorem proving problem (p).

17. The system of claim 12, wherein the theorem proving problem (p), the parameters to solve the theorem proving problem (p), and the solution of the theorem proving problem (p) are used to train a machine learning model to solve other theorem proving problems.

18. The system of claim 17, wherein the operations further comprise:
calculating, by the machine learning model, a probability of selecting each of a plurality of actions; and
performing, by the machine learning model, a sampling bias based on the probability.

19. A computer program product comprising:
a set of one or more computer-readable storage media;
program instructions, collectively stored in the set of one or more storage media, for causing a processor set to perform the following computer operations:
setting a sampling step size and a constant value as parameters to solve a theorem proving problem;
performing a first sampling step starting with an initial state of the theorem proving problem and limited by the sampling step size;
determining whether the theorem proving problem is solved;
responsive to determining that the theorem proving problem is not solved, increasing the sampling step size based on the constant value to define an increased sampling step size; and
performing a second sampling step limited by the increased sampling step size.

20. The computer program product of claim 19, wherein the operations further comprise, responsive to determining that the theorem proving problem is solved, returning a solution of the theorem proving problem.
